(19) United States
(12) Patent Application Publication
(10) Pub. No.: US 2015/0312965 A1
(43) Pub. Date: Oct. 29, 2015

(54) Electrically-Heated Clothing/Pants with Controller

(71) Applicant: PHIHONG TECHNOLOGY CO., LTD., Taoyuan County (TW)

(72) Inventors: Chun-Chen Chen, Taoyuan County (TW); Yu-Ching Huang, Taoyuan County (TW)

(21) Appl. No.: 14/680,396

(22) Filed: Apr. 7, 2015

(30) Foreign Application Priority Data
Apr. 25, 2014 (TW) 103115092

(51) Int. Cl. H05B 1/02; A41D 13/005; H05B 3/34

(52) U.S. Cl. CPC H05B 1/0272; H05B 3/342; A41D 13/0051

(57) ABSTRACT

Embodiments of the electrically-heated clothing/pants comprising: a clothing/pants, at least one battery, at least one silicone rubber heater and at least one control element. The control element is set firmly on the clothing/pants and electrical coupled with at least one battery and at least one silicone rubber heater; wherein at least one control element start to regulate electrical power from at least one battery to at least one silicone rubber heater because of opening at least one control element.

### FIELD OF THE INVENTION

The present invention relates to anelectrically-heated clothing/pantswith controller; more particularly, the present invention relates to anelectrically-heated clothing/pants using silicone rubber heaters as heating devices.

### BACKGROUND OF THE INVENTION

Currently electrically-heated clothing has multiple types of electric heating devices on the market. And wherein the electric heating device may further be of four types: laid electric heating wire, superconductive pellet, knitting conductive yarn and rubber electric heating piece in which the laid electric heating wire forms a high temperature via its contact heating by the way of utilization of laying down the electric heating wire in loops, but the present laid electric heating wire has several common disadvantages comprising: (1) the electric heating wire unevenly distributed leads to heat unevenly and cause to the effect of local overheating; (2) the electric heating wire doesn't have the waterproof itself, and if there is no additional waterproof clothing coated on the electric heating wire, the electric heating wire will produce metal oxidation corrosion in moist environment such as washing the clothes; (3) the electric heating wire sewed in the clothes, coupled with its hard characteristic, influences the shape and touch of the clothes; (4) there is any adhesive force between the electric heating wire and the clothes, thus the electric heating wire is easily dissociated from the clothes; (5) while bending the electric heating wire many times, the bending portion of the electric heating wire is broken easily and cause short circuit and leakage of electricity. Although the lighter carbon fiber heater has replaced the electric heating wire as the improvement technology of heating tools, but the disadvantages of the lighter carbon fiber heater are prohibitive, easily broken while receiving the force hit, absence of ductility and do not be supported under too large stress.

The superconductive pellet electric heating device uses the contacts of thin nickel film etched circuit to heat and form a high temperature, the front and reverse side of the thin nickel film are further attached with Mylar, a multirole plastic material, having the insulating function, while bending the electric heating wire many times, the bending portion of the electric heating wire is broken easily and cause short circuit and leakage of electricity. In addition, the knitting conductive yarn uses fine wire, which is generally metal fibers as the conductive yarn and combines with the silk, then the knitting conductive yarn is sewed in the clothes, the electrically-heated clothing with the knitting conductive yarn electric heating device is more expensive, and because there are many contacts in the knitting conductive yarn, the knitting conductive yarn doesn't loss heating function while fine wire broken unless many fine wire is broken, but the fine wire still has the oxidation problem.

Moreover, the rubber electric heating piece is the safest heater known today. The rubber electric heating piece is made by a compounded rubber pressed and rolled to shape and the wire is embedded in the rubber to form many contacts without circuit problems, the temperature disperses on each area of the rubber equally. Although the rubber electric heating piece has solder contacts, but the solder point temperature doesn't form the aggregate temperature, the rubber electric heating piece may be bended many times without producing the fracture and short circuit condition, the rubber material also has better wear resistance, higher flexibility, higher tensile strength and elongation rate. However, the rubber is aged easily while it is exposed in the air, and the rubber becomes viscous easily on being heated. Additionally, due to currently the cell for commercial electrically-heated clothing use is the 7.4 voltage lithium battery, and the 7.4 voltage lithium battery is not easily purchased on market. Consequently, the 7.4 voltage lithium battery of the clothing is hard to be replaced if it was in trouble. The placement of laid electric heating wire, superconductive pellet, knitting conductive yarn or rubber electric heating piece in commercial electrically-heated clothing is not aimed at the body areas most sensitive to cold.

In addition, in order to keep the human body safe from said electric heating devices, there is one layer or more layers of textiles added between said human body and said electric heating devices, but it will increase the distance between said human body and said electric heating devices and cause the warm ineffectively.Therefore, as previously mentioned, it need to develop a new electrically-heated device for solving many problems as mentioned above.

### SUMMARY OF THE INVENTION

In view of the above known problems, the purpose of the invention is to provide an electrically-heated clothing/pants, and the electric heating piece in the electrically-heated clothing/pants is a silicone rubber electric heating piece, and the silicone rubber electric heating piece is consisting of a conducting element and a silicone rubber. Apart from its better electrical isolation, the silicone rubber also has better heat conduction and may absorb local thermal energy produced from the conducting element and thermal energy is evenly distributed in the silicone rubber, so it could improve the disadvantage about local overheating while using the electrically-heated clothing/pants, the user's surface contacted with the silicone rubber may be heated uniformly, the user is not scalded by the silicone rubber and the silicone rubber may keep the specific body areas warm. In addition, because the silicone rubber has better waterproof function, the electrically-heated clothing/pants will be washed in moist environment such as washing the clothes.

Another purpose of the invention is to provide an improved heater structure of the electrically-heated clothing/pants, wherein said conducting elementincludes but not limited tothe cable line, metal alloy foil, conductive adhesive or metal oxide semiconductor, and while the electrically-heated clothing/pants is received the force hit, the silicone rubber may be the buffer for preventing the conducting element from breakage due to bending or hitting said conducting element. The silicone rubber of the silicone rubber electric heating piece may endure temperature up to 250° C., so even if the conducting element has sudden overheating condition, the structure of the silicone rubber still may maintain better stability.

In a first aspect of the invention, the invention of the electrically-heated clothing comprises: a clothing, at least one battery, at least one silicone rubber heater, at least one control element. The at least one control element set on the clothing is electrically connected with at least one battery and at least one silicone rubber heater; the at least one control element further comprises: a processor, a light-emitting diode module, a switching element, a oscillator, a pulse-width modulator and a output/input interphase. The switching element is coupled with the processor, and while the user opens the switching element, the switching elementmay import current from said at least one batteryto said at least one control element, wherein the oscillator is coupled with said processor for detecting importing voltage which is from at least one battery and producing a oscillation signal, and said pulse-width modulator converts the oscillation signal into a pulse signal, said pulse signal is transmitted to the light-emitting diode module via the output/input interphase coupled with the processor, wherein the at least one control element may regulate electrical power which is transmitted from at least one battery to at least one silicone rubber heater by opening at least one switching element. In some embodiments, the at least one silicone rubber heater comprises a silicone rubber and a conducting element; and wherein the at least one battery may be a 5.0 voltage lithium battery.

In a second aspect of the invention, the invention of the electrically-heated pair of pants comprises: a pair of pants, at least one battery, at least one silicone rubber heater, at least one control element. The at least one control element set on the clothing is electrically connected with at least one battery and at least one silicone rubber heater; the at least one control element further comprises: a processor, a light-emitting diode module, a switching element, a oscillator, a pulse-width modulator and a output/input interphase. The switching element is coupled with the processor, and while the user opens the switching element, the switching element may import current from said at least one battery to said at least one control element, wherein the oscillator is coupled with said processor for detecting importing voltage which is from at least one battery and producing a oscillation signal, and said pulse-width modulator converts the oscillation signal into a pulse signal, said pulse signal is transmitted to the light-emitting diode module via the output/input interphase coupled with the processor, wherein the at least one control element may regulate electrical power which is transmitted from at least one battery to at least one silicone rubber heater by opening at least one switching element. In some embodiments, the at least one silicone rubber heater comprises a silicone rubber and a conducting element.

In a third aspect of the invention, the at least one silicone rubber heater comprises a silicone rubber and a conducting element, wherein the conducting element may further be a cable line, a metal alloy foil, a conductive adhesive or a metal oxide semiconductor. The control element performs multi-stage regulationto control electrical power which is transmitted from at least one battery to at least one silicone rubber heater.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is illustrated as a diagram of basic structure of an electrically-heated clothing.

FIG. 2 is illustrated as a diagram of basic structure of an electrically-heated pair of pants.

FIG. 3 is illustrated as a diagram of basic structure of interior elements in a control element according to one embodiment.

DETAILED DESCRIPTION OF THE PRESENT INVENTION

An implementation of the invention is illustrated by the following specific embodiments, the person who is familiar with the technique may easily realize the efficiency and its advantages disclosed from the specification content. The invention also may use other specific embodiments to utilize and implement, each detail illustrated in the specification may be applied based on different needs and various kinds of modifications and alterations are not departed under the spirit of the invention.

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

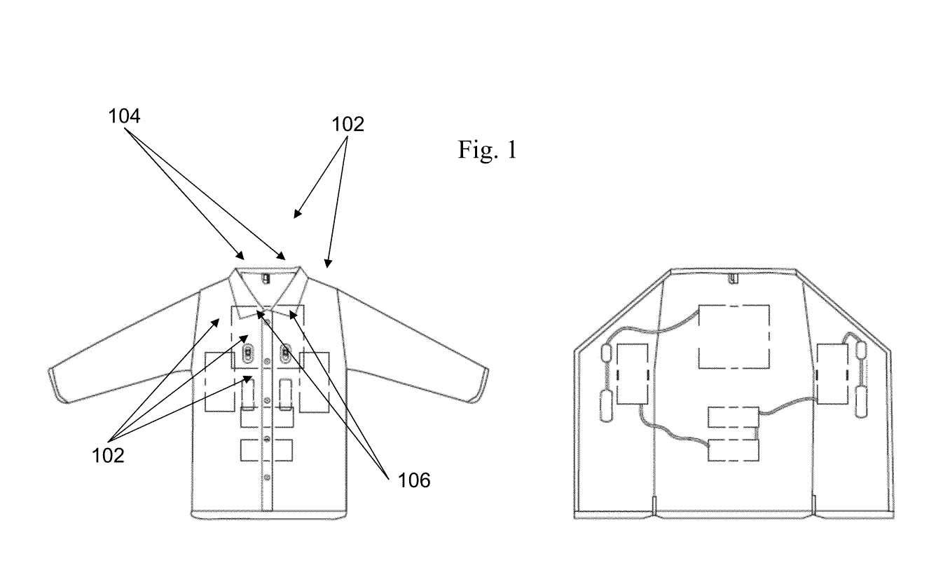

As shown in FIG. 1, it is illustrated as a diagram of basic structure of an electrically-heated clothing. The embodiment of the electrically-heated clothing further includes: a clothing, at least one silicone rubber heater 102, at least one battery 106, at least one control element 104, wherein said at least one control element 104 set on said clothing is electrically connected with at least one battery and at least one silicone rubber heater; wherein the electrical power in said at least one battery may be transmitted to said at least one silicone rubber heater for converting electrical power to thermal energy. In some embodiments, wherein a plurality of pockets are sewed on the clothing, several pockets on the front of clothing and several pockets on the back of clothing, and the at least one silicone rubber heater is placed separately in the plurality of pockets.

In some embodiments, there are two pockets sewed on the front of electrically-heated clothing, and there are three pockets sewed on the back of electrically-heated clothing, then the silicone rubber heaters are placed separately in said pockets. The presentation of silicone rubber heaters in the front of electrically-heated clothing is designed for keeping the chest and heart areas warm; additionally, the presentation of silicone rubber heaters in the back of electrically-heated clothing is designed for keeping the back and waist areas warm. In some embodiments, wherein a plurality of pockets are sewed on the clothing, two pockets on the front of clothing and two pockets on the back of clothing, and the at least one silicone rubber heater is placed separately in the plurality of pockets, and wherein one control element is set on the front of electrically-heated clothing, there is one pocket sewed under said control element on the front of clothing for placement of the battery.

In one embodiment, wherein the at least one battery used by the electrically-heated clothing is the 5V lithium battery. In one embodiment, the battery used by the electrically-heated clothing is a graphene battery.

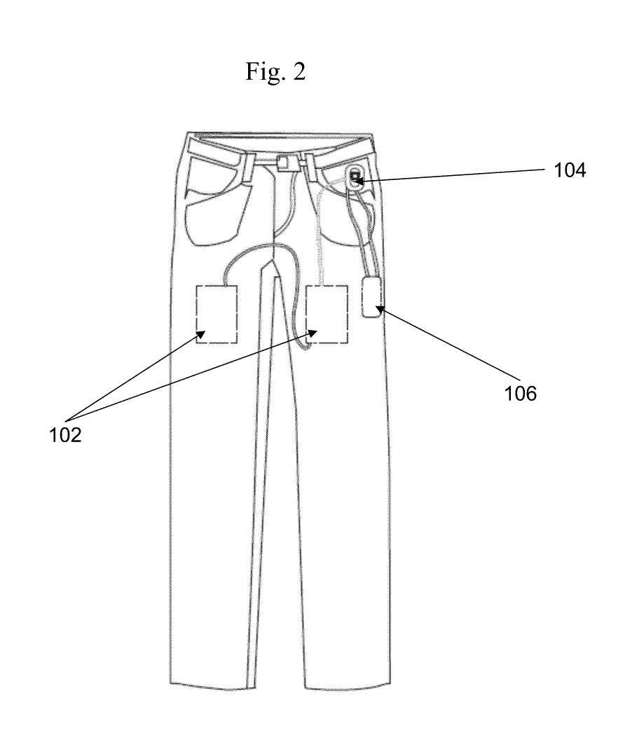

As shown in FIG. 2, it is illustrated as a diagram of basic structure of an electrically-heated pair of pants. The embodiment of the electrically-heated pair of pants 200 further includes: a pair of pants, at least one silicone rubber heater 102, at least one control element 104, at least one battery 106, wherein said at least one control element 104 set on said pants is electrically connected with at least one battery and at least one silicone rubber heater; wherein the electrical power in said at least one battery may be transmitted to said at least one silicone rubber heater for converting electrical power to thermal energy; wherein said battery may be a 5V lithium battery. In some embodiments, wherein a plurality of pockets are sewed on the leg of pants, and the at least one battery is placed separately in the plurality of pockets. In one embodiment, wherein a plurality of pockets are sewed on the electrically-heated pair of pants, several pockets on the seat of pants and several pockets on the leg of pants, and said silicone rubber heaters are placed separately in the plurality of pockets. In one embodiments,the battery used by the electrically-heated pair of pants may be a graphene battery. In other embodiments, wherein the at least one silicone rubber heater of the electrically-heated clothing/pants may be electrically connected with other silicone rubber heaters via a wire.

In some embodiments, there are two pockets sewed on the pair of pants, then the batteries are placed separately in said pockets. In one embodiment, there are three pockets sewed on the pair of pants, one pocket on the seat of pants and two pockets on the leg of pants, then the at least one silicone rubber heater is placed separately in said pockets. The presentation of heaters in the electrically-heated pair of pants is designed for keeping the back ofseat and leg areas warm.

In some embodiments, the silicone rubber heater used in the electrically-heated clothing/pants comprises: a silicone rubber and a conducting element, and the conducting element may further be one of a cable line, a metal alloy foil, a conductive adhesive and a metal oxide semiconductor. In some embodiments, said silicone rubber is used as an insulator to coat the conducting element completely, the silicone rubber may fully absorb thermal energy produced from the conducting element. In some embodiments, the conducting element is a tablet-shaped structure or a plurality of microstructures, and the plurality of microstructuresis arranged in a pattern selected from the group consisting of one or more pattern, a spiral pattern, a horseshoe pattern, a herringbone pattern, one or more herringbone pattern, one or more pattern of clustered microstructures, and various combinations thereof In some embodiments, the conducting element may further be bent to “U” type or “S” type, then placed in the silicone rubber.

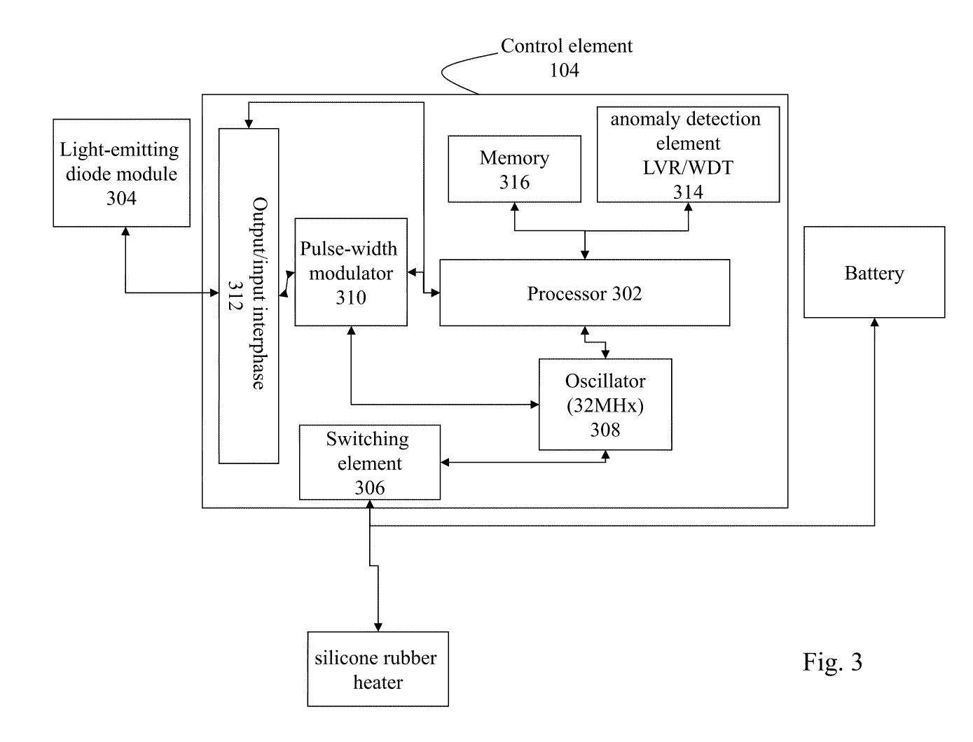

FIG. 3 is illustrated as a diagram of basic structure of interior elements in a control element according to one embodiment. In one embodiment, the control element further comprises: a processor 302, a light-emitting diode module 304, a switching element 306, an oscillator 308, a pulse-width modulator 310 and an output/input interphase 312. The switching element is coupled with the processor, and while the user opens the switching element, the switching element may import current which is from said at least one battery to said at least one control element, wherein the oscillator is coupled with said processor for detecting importing voltage which is from at least one battery and producing a oscillation signal, and said pulse-width modulator converts the oscillation signal into a pulse signal, said pulse signal is transmitted to the light-emitting diode module via the output/input interphase coupled with the processor, wherein the at least one control element may regulate electrical power which is transmitted from at least one battery to at least one silicone rubber heater by opening at least one switching element. In one embodiment, the control element further includes an anomaly detection element 314 for detecting if electrical power which is from the at least one battery to the at least one silicone rubber heater is in the exceptional condition. In some embodiment, the control element further may be applied to other electrically-heated accessories, including but not limited to electrically-heated belt, gloves, insole and earmuffs.

In one embodiment, the use of the electrically-heated clothing/pants may further be divided into a general mode and a power saving mode. In said general mode, the user may use a 32 MHx oscillator to produce an oscillation signal. In another embodiment, while in said power saving mode, the user may use a 458.752 kHZ oscillator to reduce the electrical power from said at least one battery. In one embodiment, said control element further comprises a memory 316, the memory is coupled with the processor for storing some operating instructions.

In one specific embodiment, while the holes of the silicone rubber of the silicone rubber heater are 7.5-8 5 mm in diameterused in the electrically-heated clothing/pants, the silicone rubber heater may still maintain the temperature range that is desirable when the control element switches different output of electrical power; in another embodiment, saidholes of the silicone rubber of said silicone rubber heater with a diameter of 8 mm are optimal.

In another embodiment, the control element may further be analog controller, logic circuit and microcontroller, wherein the controllermay use a multi-stage switch to regulate the amount electrical power which is transmitted from said at least one battery to said at least one silicone rubber heater and cause the light-emitting diode module to produce different lights, and different lights indicate the temperature range of the surface of the silicone rubber heater. In one embodiment, the control element may use three-stage switch to provide said at least one silicone rubber heater for three different temperature ranges.

The foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

1. An electrically-heated clothing with controller, comprising:
a clothing;
at least one battery;
at least one silicone rubber heater including a silicone rubber and a conducting element;
at least one control element set on the clothing, electrically connected with said at least one battery and said at least one silicone rubber heater and further comprising:
a process;
a light-emitting diode module; and
a switching element coupled with said processor, while opening said switching element, said switching element may import current from said at least one battery to said at least one control element;
a oscillator coupled with said processor for detecting importing voltage which is from at least one battery and producing a oscillation signal; and
a pulse-width modulator coupled with said processor for converting said oscillation signal into a pulse signal;
a output/input interphase coupled with said processor for transmitting said pulse signal to said light-emitting diode module;
wherein said at least one control element may regulate electrical power which is transmitted from at least one battery to at least one silicone rubber heater by opening at least one switching element.

2. An electrically-heated pants with controller, comprising:
a pair of pants;
at least one battery;
at least one silicone rubber heater including a silicone rubber and a conducting element;
at least one control element set on the pants, electrically connected with said at least one battery and said at least one silicone rubber heater and further comprising:
a process;
a light-emitting diode module; and
a switching element coupled with said processor, while opening said switching element, said switching element may import current from said at least one battery to said at least one control element;
a oscillator coupled with said processor for detecting importing voltage which is from at least one battery and producing a oscillation signal; and
a pulse-width modulator coupled with said processor for converting said oscillation signal into a pulse signal;
a output/input interphase coupled with said processor for transmitting said pulse signal to said light-emitting diode module;
wherein said at least one control element may regulate electrical power which is transmitted from at least one battery to at least one silicone rubber heater by opening at least one switching element.

3. The clothing of claim 1, wherein said at least one silicone rubber heater_is electrically connected with other silicone rubber heaters.

4. The clothing of claim 1, wherein said conducting element is one of cable line, metal alloy foil, conductive adhesive or metal oxide semiconductor.

5. The clothing of claim 1, wherein said holes of silicone rubber of the silicone rubber heater are 7.5˜8.5 mm in diameter.

6. The clothing of claim 1, wherein said holes of silicone rubber of the silicone rubber heater are 8 mm in diameter.

7. The clothing of claim 1, wherein said conducting element is a tablet-shaped structure or a plurality of microstructures, and said plurality of microstructure is arranged in a pattern selected from the group consisting of one or more pattern, a spiral pattern, a horseshoe pattern, a herringbone pattern, one or more herringbone pattern, one or more pattern of clustered microstructures, and various combinations thereof.

8. The clothing of claim 1, wherein said conducting element is further bent to “U” type or “S” type and placed in said silicone rubber.

9. The clothing of claim 1, wherein there are two pockets sewed on the front of clothing, then the at least one battery is placed separately in said pockets.

10. The pants of claim 2, wherein there are two pockets sewed on the pair of pants, then the batteries are placed separately in said pockets.

11. The pants of claim 2, wherein there are three pockets sewed on the pair of pants, one pocket on the seat of pants and two pockets on the leg of pants and the at least one silicone rubber heater is placed separately in said pockets.

12. The pants of claim 2, wherein said conducting element is a tablet-shaped structure or a plurality of microstructures, and said plurality of microstructures is arranged in a pattern selected from the group consisting of one or more pattern, a spiral pattern, a horseshoe pattern, a herringbone pattern, one or more herringbone pattern, one or more pattern of clustered microstructures, and various combinations thereof.

13. The clothing of claim 1, wherein said at least one control element regulates said amount electrical power which is transmitted from said at least one battery.

14. The clothing of claim 1, wherein said control element includes further comprises a memory, the memory is coupled with the processor for storing some operating instructions.

15. The clothing of claim 1, wherein said control element includes an anomaly detection element for detecting if electrical power which is from said at least one battery to said at least one silicone rubber heater is in an exceptional condition.

16. The clothing of claim 14, wherein said control element further includes a 32 MHx oscillator and a 458.752 kHz oscillator.

17. The clothing of claim 1, wherein the at least one battery is a 5V lithium battery.

18. The clothing of claim 1, wherein the at least one battery is a graphene battery.

19. The clothing of claim 15, wherein said control element further includes a 32 MHx oscillator and a 458.752 kHz oscillator.
